(19) United States
(12) Patent Application Publication
(10) Pub. No.: US 2025/0256256 A1
(43) Pub. Date: Aug. 14, 2025

(54) AGING AND EXTRACTION OF WET GELS IN A SINGLE VESSEL

(71) Applicant: Aspen Aerogels, Inc., Northborough, MA (US)

(72) Inventors: Ryan Tarrant, Northborough, MA (US); Herbert Klei, Northborough, MA (US); Harold Klei, Northborough, MA (US); Joseph Fraser, Northborough, MA (US); Andrew Klei, Northborough, MA (US)

(73) Assignee: Aspen Aerogels, Inc., Northborough, MA (US)

(21) Appl. No.: 19/177,111

(22) Filed: Apr. 11, 2025

Related U.S. Application Data
(63) Continuation of application No. PCT/IB2023/060138, filed on Oct. 9, 2023.
(60) Provisional application No. 63/416,017, filed on Oct. 14, 2022.

(51) Int. Cl. B01J 13/00; C01B 33/158

(52) U.S. Cl. CPC B01J 13/0091; C01B 33/1585

(57) ABSTRACT

Described herein is a method of aging a wet gel material. The method comprises aging a wet gel material by heating the wet gel material in an aging fluid at an aging temperature above the normal boiling point of the aging fluid. This is accomplished by maintaining the pressure of aging fluid above the vapor pressure of the aging fluid during heating.

### CROSS REFERENCES TO RELATED APPLICATIONS

This application is a continuation of International PCT Application No. PCT/IB2023/060138 filed Oct. 9, 2023, which claims priority to and the benefit of U.S. Provisional Patent Application No. 63/416,017, filed Oct. 14, 2022, both of which are herein incorporated by reference in their entireties.

### TECHNICAL FIELD

The invention relates generally to aerogel technology. The invention relates more particularly, in various embodiments, to improved methods for producing aerogels and improved aerogel composites.

### BACKGROUND

Low-density aerogel materials are widely considered to be the best solid insulators available. Aerogels function as insulators primarily by minimizing conduction (low structural density results in tortuous path for energy transfer through the solid framework), convection (large pore volumes and very small pore sizes result in minimal convection), and radiation (IR absorbing or scattering dopants are readily dispersed throughout the aerogel matrix). Aerogels can be used in a broad range of applications, including: heating and cooling insulation, acoustics insulation, electronic dielectrics, aerospace, energy storage and production, and filtration. Furthermore, aerogel materials display many other interesting acoustic, optical, mechanical, and chemical properties that make them abundantly useful in various insulation and non-insulation applications.

Large-scale production of aerogel materials or compositions can be complicated by difficulties related to the continuous formation of gel materials on a large scale; as well as the difficulties related to liquid phase extraction from gel materials in large volumes. It is desirable to develop efficient techniques for the large-scale production of aerogel materials.

### SUMMARY

It is an object of the present disclosure to obviate or mitigate at least one disadvantage of previous methods and materials mentioned above. The methods and systems described herein are designed to improve the process of making aerogel materials.

In an aspect of the disclosure, a method of aging a wet gel material comprises: placing the wet gel material in a vessel; introducing an aging fluid into the vessel; aging the wet gel material by heating the wet gel material and the aging fluid at an aging temperature and an aging pressure, wherein the aging temperature is above the normal boiling point of the aging fluid, wherein the pressure of the vessel is maintained above the vapor pressure of the aging fluid during heating.

In an aspect of the disclosure, the wet gel material is obtained by the method comprising: providing a precursor solution comprising silica gel precursor materials and a solvent; and allowing the silica gel precursor materials in the precursor solution to transition into a wet gel material, wherein the wet gel material comprises a silica-based framework and the solvent.

In an aspect of the disclosure, the aging fluid comprises ethanol. In a further aspect of the disclosure the aging pressure is a pressure above the vapor pressure of the aging fluid at the aging temperature and the aging temperature is above the critical temperature of CO₂. In an exemplary aspect the wet gel material and aging fluid are heated to an aging temperature of between about 80 C (176 F) and about 110 C (230 F) at an aging pressure between about 1000 psi and about 2500 psi during aging of the wet gel material. In another exemplary aspect, the wet gel material and aging fluid are heated to an aging temperature of between about 95 C (203 F) and about 110 C (230 F) at an aging pressure between about 1000 psi and about 1500 psi during aging of the wet gel material. In an exemplary aspect, the wet gel material is aged for a time between about 1 hour and about 24 hours. In another exemplary aspect, the wet gel material is aged for a time between about 40 minutes and about 200 minutes. In an aspect of the disclosure, the wet gel material is aged for a time determined from the aging temperature and the normal severity factor.

In an aspect of the disclosure, during aging of the wet gel material, aging fluid is removed and aging fluid is introduced substantially continuously. In an aspect of the disclosure, the wet gel material is washed with the aging fluid prior to heating the wet gel material. The aging fluid removes and replaces at least a portion of a liquid present in the wet gel material.

In an aspect of the disclosure, the wet gel material comprises a reinforcement material. The reinforcement material can be in the form of a continuous sheet.

In a further aspect of the disclosure, a method of producing an aerogel composition, comprises: placing a wet gel material in a vessel; introducing an aging fluid into the vessel; heating the wet gel material and the aging fluid at an aging temperature and an aging pressure, wherein the aging temperature is above the normal boiling point of the aging fluid, wherein the pressure of the vessel is maintained above the vapor pressure of the aging fluid during heating; and extracting the aging fluid from the aged gel material with an extraction fluid at an extraction temperature and an extraction pressure, wherein the extraction temperature and the extraction pressure are greater than the critical temperature and critical pressure of the extraction fluid; wherein heating the wet gel material and extracting the aging fluid from the aged gel material are performed in the vessel without removing the aged gel material from the vessel between the heating and extraction steps, and without lowering the temperature or pressure of the vessel between the heating and extraction steps.

In an aspect of the disclosure, extracting the aging fluid from the aged gel material comprises: introducing the extraction fluid into the vessel, wherein the temperature and pressure of the extraction fluid entering the vessel is substantially the same as the aging temperature and aging pressure; and adjusting the temperature and pressure inside the vessel to maintain the extraction fluid in the supercritical state. In an aspect of the disclosure, during extraction of the aging fluid from the aged gel material, extraction fluid is removed and extraction fluid is introduced substantially continuously during the extraction.

In an aspect of the disclosure, the extraction process includes monitoring the density of the extraction fluid that is removed from the vessel. The extraction of the aging fluid can be continued until the density of the extraction fluid that is removed from the vessel is within 10% of the density of the extraction fluid entering the vessel. When the extraction fluid is supercritical carbon dioxide (CO₂) the extraction process includes adjusting the pressure and/or temperature inside the vessel to maintain the density of the supercritical fluid between about 0.30 g/cc and 0.60 g/cc.

In an aspect of the disclosure, the extraction process further includes removing fluid from the vessel when the extraction fluid is introduced into the vessel, wherein the removed fluid comprises at least a portion of the aging fluid.

In an aspect of the disclosure, the aging pressure is maintained at or above the critical pressure of the extraction fluid and above the critical temperature during heating of the wet gel material to form an aged gel material. In another aspect of the disclosure, the aging temperature and the aging pressure are raised to the extraction temperature and the extraction pressure prior to introducing the extraction fluid into the vessel.

In an aspect of the disclosure, a method of producing an aerogel composition, comprising: placing a wet gel material in a vessel, the wet gel comprising a silica-based framework; introducing ethanol into the vessel; aging the wet gel material by heating the wet gel material and the ethanol at an aging temperature and an aging pressure, wherein the aging temperature is above 80 C (186 F), and wherein the pressure of the vessel is maintained above 1000 psi during heating; introducing carbon dioxide into the vessel, wherein the temperature and pressure of the carbon dioxide entering the vessel is substantially the same as the aging temperature and aging pressure; extracting the aging fluid from the aged gel material with supercritical carbon dioxide at an extraction temperature and an extraction pressure; and adjusting the extraction temperature and/or extraction pressure inside the vessel to maintain the carbon dioxide in a supercritical state; wherein heating the wet gel material and extracting the aging fluid from the aged gel material are performed in the vessel without removing the aged gel material from the vessel between the heating and extraction steps, and without lowering the temperature or pressure of the vessel between the heating and extraction steps.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic diagram of a traditional method of processing a continuous roll of an aerogel

FIG. 2 depicts a schematic diagram of the improved process in which aging and extraction of the wet gel material is accomplished in the same vessel.

FIG. 3 depicts a schematic diagram of this process superimposed over the phase diagram of CO₂.

FIG. 4A, FIG. 4B, and FIG. 4C show a comparison of the physical properties of a gel material produced using the combined aging/extraction process compared to a standard process in which aging and extraction are performed in different vessels.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the form disclosed, but to the contrary, the intention is to cover all modifications, equivalents, and alternatives falling within the spirit and scope of the present invention as defined by the appended claims.

### DETAILED DESCRIPTION

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Aerogels are a class of porous materials with open-cells comprising a framework of interconnected structures, with a corresponding network of pores integrated within the framework, and an interstitial phase within the network of pores which is primarily comprised of gases such as air. Aerogels are typically characterized by a low density, a high porosity, a large surface area, and small pore sizes. Aerogels can be distinguished from other porous materials by their physical and structural properties.

Within the context of the present disclosure, in some examples, the terms “framework” or “framework structure” refer to the network of nanoscopic and/or microscopic structural elements, such as fibrils, struts, and/or colloidal particles that form the solid structure of a gel or an aerogel. The structural elements that make up the framework structures have at least one characteristic dimension (e.g., length, width, diameter) of about 100 angstroms or less. In examples of pyrolyzed or carbonized aerogels, the terms “framework” or “framework structure” may refer to an interconnected network of linear fibrils, nanoparticles, a bicontinuous network (e.g., networks transitioning between a fibrillar and spherical morphology with aspects of both), or combinations thereof. In some examples, the linear fibrils, nanoparticles, or other structural elements may be connected together (at nodes in some examples) to form a framework that defines pores.

As used herein, the terms “aerogel” and “aerogel material” refer to a solid object, irrespective of shape or size, comprising a framework of interconnected solid structures, with a corresponding network of interconnected pores integrated within the framework, and containing gases such as air as a dispersed interstitial medium. As such, aerogels are open non-fluid colloidal or polymer networks that are expanded throughout their whole volume by a gas, and are formed by the removal of all swelling agents from a corresponding wet-gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 50 m²/g or more, such as from about 100 to about 1500 m²/g by nitrogen sorption analysis. It can be understood that the inclusion of additives, such as a reinforcement material, may decrease porosity and the specific surface area of the resulting aerogel composite. Densification may also decrease porosity of the resulting aerogel composite. Aerogel materials of the present disclosure include any aerogels which satisfy the defining elements set forth in the previous paragraph.

Aerogels as disclosed herein have a pore size distribution. As used herein, the term “pore size distribution” refers to the statistical distribution or relative amount of each pore size within a sample volume of a porous material. A narrower pore size distribution refers to a relatively large proportion of pores at a narrow range of pore sizes. In some embodiments, a narrow pore size distribution may be desirable in e.g., optimizing the amount of pores that can surround an electrochemically active species and maximizing use of the available pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart. The pore size distribution of a porous material may be determined by methods known in the art, for example including, but not limited to, surface area, skeletal density, and porosimetry, from which pore size distribution can be calculated. Suitable methods for determination of such features include, but are not limited to, measurements of gas adsorption/desorption (e.g., nitrogen), helium pycnometry, mercury porosimetry, and the like. Measurements of pore size distribution reported herein are acquired by nitrogen sorption analysis unless otherwise stated.

Aerogel materials or compositions of the present disclosure can have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

Aerogels as disclosed herein have a pore volume. As used herein, the term “pore volume” refers to the total volume of pores within a sample of porous material. Pore volume is specifically measured as the volume of void space within the porous material, and is typically recorded as cubic centimeters per gram (cm3/g or cc/g). The pore volume of a porous material may be determined by methods known in the art, for example including, but not limited to, surface area and porosity analysis (e.g. nitrogen porosimetry, mercury porosimetry, helium pycnometry, and the like). In certain embodiments, polyimide or carbon aerogels of the present disclosure have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, polyimide or carbon aerogels and xerogels of the present disclosure have a pore volume of about 0.03 cc/g or more, 0.1 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

An aerogel framework can be made from a range of precursor materials, including: inorganic precursor materials (such as precursors used in producing silica-based aerogels); organic precursor materials (such precursors used in producing carbon-based aerogels); hybrid inorganic/organic precursor materials; and combinations thereof. Within the context of the present disclosure, the term “amalgam aerogel” refers to an aerogel produced from a combination of two or more different gel precursors. Within the context of the present disclosure, the terms “framework” or “framework structure” refer to the network of interconnected oligomers, polymers or colloidal particles that form the solid structure of a gel or an aerogel. The polymers or particles that make up the framework structures typically have a diameter of about 100 angstroms. However, framework structures of the present disclosure can also include networks of interconnected oligomers, polymers or colloidal particles of all diameter sizes that form the solid structure within in a gel or aerogel. Furthermore, the terms “silica-based aerogel” or “silica-based framework” refer to an aerogel framework in which silica comprises at least 50% (by weight) of the oligomers, polymers or colloidal particles that form the solid framework structure within in the gel or aerogel.

Inorganic aerogels are generally formed from metal oxide or metal alkoxide materials. The metal oxide or metal alkoxide materials can be based on oxides or alkoxides of any metal that can form oxides. Such metals include, but are not limited to: silicon, aluminum, titanium, zirconium, hafnium, yttrium, vanadium, cerium, and the like. Inorganic silica aerogels are traditionally made via the hydrolysis and condensation of silica-based alkoxides, or via gelation of silicic acid or water glass. Inorganic precursor materials for silica based aerogel synthesis include, but are not limited to: metal silicates such as sodium silicate or potassium silicate; alkoxysilanes such as tetraethoxysilane (TEOS), tetramethoxysilane (TMOS), and tetra-n-propoxysilane; partially hydrolyzed alkoxysilanes such as partially hydrolyzed TEOS and partially hydrolyzed TMOS; condensed polymers of alkoxysilanes such as condensed polymers of TEOS and condensed polymers of TMOS; alkylalkoxy silanes, and combinations thereof.

In certain aspects of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors which comprise at least one hydrophobic group, such as alkyl metal alkoxides, cycloalkyl metal alkoxides, and aryl metal alkoxides, which can impart or improve certain properties in the gel such as stability and hydrophobicity. Within the context of the present disclosure, the term “hydrophobicity” refers to a measurement of the ability of an aerogel material or composition to repel water. Hydrophobicity of an aerogel material or composition can be expressed by measuring the equilibrium contact angle of a water droplet at the interface with the surface of the material. Aerogel materials or compositions of the present disclosure that have a water contact angle greater than 90° are considered hydrophobic. Aerogel materials or compositions that have a water contact angle that is less than 90° are considered hydrophilic.

Inorganic silica aerogels can specifically include hydrophobic precursors such as alkylsilanes or arylsilanes. Hydrophobic gel precursors can be used as primary precursor materials to form the framework of a gel material. However, hydrophobic gel precursors are more commonly used as co-precursors in combination with metal alkoxides in the formation of amalgam aerogels. Hydrophobic inorganic precursor materials for silica based aerogel synthesis include, but are not limited to: trimethyl methoxysilane [TMS], dimethyl dimethoxysilane [DMS], methyl trimethoxysilane [MTMS], trimethyl ethoxysilane, dimethyl diethoxysilane [DIVIDES], methyl triethoxysilane [MTES], ethyl triethoxysilane [ETES], diethyl diethoxysilane, ethyl triethoxysilane, propyl trimethoxysilane, propyl triethoxysilane, phenyl trimethoxysilane, phenyl triethoxysilane [PhTES], hexamethyldisilazane and hexaethyldisilazane.

In exemplary aspects of the present disclosure, the relative amount of hydrophobic gel precursor or precursors to other inorganic precursor materials is selected to provide an aerogel material or composition having hydrophobic properties as disclosed herein while maintaining other properties such as thermal conductivity, heat of combustion, onset of thermal decomposition, and/or processability. For example, the use of lower amounts of hydrophobic gel precursor or precursors can reduce the hydrophobic properties, e.g., provide a material having a higher liquid water uptake or water vapor uptake. The use of higher amounts of hydrophobic gel precursor or precursors can negatively impact thermal conductivity, combustion and/or self-heating properties. In exemplary embodiments, hydrophobic aerogel materials and compositions of the present disclosure can have a hydrophobe content of about 20 wt %, about 30 wt %, about 40 wt %, about 50 wt % or in a range between any two of these values. For example, an exemplary aerogel composition has a hydrophobe content of about 36 wt %. Further details regarding the synthesis and characterization of hydrophobic aerogels are described in U.S. Patent Application Publication No. 2016/0096949 to Evans et al, which is incorporated herein by reference.

Production of an aerogel generally includes the following steps: i) formation of a sol-gel solution; ii) formation of a gel from the sol-gel solution; and iii) extracting the solvent from the gel materials to obtain a dried aerogel material. This process is discussed below in greater detail, specifically in the context of forming inorganic aerogels such as silica aerogels. However, the specific examples and illustrations provided herein are not intended to limit the present disclosure to any specific type of aerogel and/or method of preparation. The present disclosure can include any aerogel formed by any associated method of preparation known to those in the art.

The first step in forming an inorganic aerogel is generally the formation of a precursor solution through hydrolysis and condensation of metal alkoxide precursors in an alcohol-based solvent. Major variables in the formation of inorganic aerogels include the type of alkoxide precursors included in the precursor solution, the nature of the solvent, the processing temperature and pH of the precursor solution (which may be altered by addition of an acid or a base), and precursor/solvent/water ratio within the precursor solution. Control of these variables in forming a precursor solution can permit control of the growth and aggregation of the gel framework during the subsequent transition of the gel material from the “sol” state to the “gel” state. While properties of the resulting aerogels are affected by the pH of the precursor solution and the molar ratio of the reactants, any pH and any molar ratios that permit the formation of gels may be used in the present disclosure.

A precursor solution is formed by combining at least one gelling precursor with a solvent. Suitable solvents for use in forming a precursor solution include lower alcohols with 1 to 6 carbon atoms including any integer therebetween, preferably 2 to 4, although other solvents can be used as known to those with skill in the art. Examples of useful solvents include, but are not limited to: methanol, ethanol, isopropanol, ethyl acetate, ethyl acetoacetate, acetone, dichloromethane, tetrahydrofuran, and the like. Multiple solvents can also be combined to achieve a desired level of dispersion or to optimize properties of the gel material. Selection of optimal solvents for the sol-gel and gel formation steps thus depends on the specific precursors, fillers and additives being incorporated into the sol-gel solution; as well as the target processing conditions for gelling and liquid phase extraction, and the desired properties of the final aerogel materials.

Water can also be present in the precursor solution. The water acts to hydrolyze the metal alkoxide precursors into metal hydroxide precursors. The hydrolysis reaction can be (using TEOS in ethanol solvent as an example).

Si(OC₂H₅)₄+4H₂O→Si(OH)₄+4(C₂H₅OH) (1)

The resulting hydrolyzed metal hydroxide precursors remain suspended in the precursor solution in a “sol” state, either as individual molecules or as small polymerized (or oligomarized) colloidal clusters of molecules. For example, polymerization/condensation of the Si(OH)₄ precursors can occur as follows:

2Si(OH)₄→(OH)₃Si—O—Si(OH)₃+H₂O (2),

This polymerization can continue until colloidal clusters of polymerized (or oligomarized) SiO₂ (silica) molecules are formed.

Acids and bases can be incorporated into the precursor solution to control the pH of the precursor solution, and to catalyze the hydrolysis and condensation reactions of the precursor materials. While any acid may be used to catalyze precursor reactions and to obtain a lower pH solution, preferable acids include: HCl, H₂SO₄, H₃PO₄, oxalic acid and acetic acid.

Any base may likewise be used to catalyze precursor reactions and to obtain a higher pH solution. In an aspect of the present disclosure bases can be used to catalyze the precursor reactions or adjust the pH of the precursor solution. In an aspect of the present disclosure, metal hydroxide bases can be used to catalyze the precursor reactions or adjust the pH of the precursor solution. Exemplary metal hydroxide bases include, but are not limited to, sodium hydroxide, lithium hydroxide, calcium hydroxide, potassium hydroxide, strontium hydroxide, and barium hydroxide. In another aspect of the present disclosure, amine bases can be used to be used to catalyze precursor reactions and/or adjust the pH of the precursor solution. Exemplary amine bases include, but are not limited to, tetraalkylammonium hydroxides, choline hydroxide, trialkylamines, amidines, guanidines and imidazoles. Specific examples of amine bases include tetramethylammonium hydroxide, tetrabutylammonium hydroxide, guanidine, 1,8-Diazabicyclo[5.4.0]undec-7-ene (DBU), 1,4-diazabicyclo[2.2.2]octane (DABCO), pyridine, imidazole, and 4,5-dihydroimidazole.

The precursor solution can include additional co-gelling precursors, as well as filler materials and other additives. Filler materials and other additives may be dispensed in the precursor solution at any point before or during the formation of a gel. Filler materials and other additives may also be incorporated into the gel material after gelation through various techniques known to those in the art. Preferably, the precursor solution comprising the gelling precursors, solvents, catalysts, water, filler materials and other additives is a homogenous solution which is capable of effective gel formation under suitable conditions.

Once a precursor solution has been formed and optimized, the gel-forming components in the precursor solution can be transitioned into a gel material. The process of transitioning gel-forming components into a gel material comprises an initial gel formation step wherein the gel solidifies up to the gel point of the gel material. The gel point of a gel material may be viewed as the point where the gelling solution exhibits resistance to flow and/or forms a substantially continuous polymeric framework throughout its volume. A range of gel-forming techniques are known to those in the art. Examples include, but are not limited to: maintaining the mixture in a quiescent state for a sufficient period of time; adjusting the pH of the solution; adjusting the temperature of the solution; directing a form of energy onto the mixture (ultraviolet, visible, infrared, microwave, ultrasound, particle radiation, electromagnetic); or a combination thereof.

In certain embodiments, gel materials of the present disclosure can be produced through a continuous casting and gelation process. In a continuous casting process, a continuous sheet of fibrous material can be used as a support during a continuous casting process. The fibrous support can improve the flexibility and/or strength of the aerogel material. In an aspect of the present disclosure an aerogel composite is formed by adding a gel precursor composition to a fiber reinforcing material and forming a wet gel from the gel precursor composition. In an aspect of the present disclosure, the precursor solution is incorporated into a fiber reinforcement material and the resulting composite material formed into a fiber supported wet gel material.

During large scale production of an aerogel, the fiber reinforcement material is in the form of a continuous sheet of interconnected or interlaced fiber reinforcement materials. The precursor solution is incorporated into the aerogel composite as continuous sheet of interconnected or interlaced fiber reinforcement materials. The initial wet gel material is produced as a continuous sheet of fiber reinforced gel by casting or impregnating a gel precursor solution into a continuous sheet of an interconnected or an interlaced fiber reinforcement material. As will be described in more detail, the liquid phase may then be at least partially extracted from the fiber-reinforced wet gel material to produce a sheet-like, fiber reinforced aerogel composite.

Aerogel composites may be fiber-reinforced with various fiber reinforcement materials to achieve a more flexible, resilient and conformable composite product. Fiber reinforcement materials may be in the form of discrete fibers, woven materials, non-woven materials, battings, webs, mats, and felts. Fiber reinforcements can be made from organic fibrous materials, inorganic fibrous materials, or combinations thereof. Fiber reinforcement materials can comprise a range of materials, including, but not limited to: polyesters, polyolefin terephthalates, poly (ethylene) naphthalate, polycarbonates (examples Rayon, Nylon), cotton, (e.g. lycra manufactured by DuPont), carbon (e.g. graphite), polyacrylonitriles (PAN), oxidized PAN, uncarbonized heat treated PANs (such as those manufactured by SGL carbon), fiberglass based material (like S-glass, 901 glass, 902 glass, 475 glass, E-glass,) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), silicon carbide fibers like Nicalon (manufactured by COI Ceramics), ceramic fibers like Nextel (manufactured by 3M), acrylic polymers, wool fibers, silk, hemp, leather, suede, PBO-Zylon fibers (manufactured by Tyobo), liquid crystal material like Vectan (manufactured by Hoechst), cambrelle fiber (manufactured by DuPont), polyurethanes, polyamides, metal fibers such as boron, aluminum, iron, and stainless steel fibers, and thermoplastics like PEEK, PES, PEI, PEK, PPS, Aerogel composites of the present disclosure can have a thickness of 15 mm or less, 10 mm or less, 5 mm or less, 3 mm or less, 2 mm or less, or 1 mm or less.

Aerogel composites of the present disclosure can have a thickness of 15 mm or less, 10 mm or less, 5 mm or less, 3 mm or less, 2 mm or less, or 1 mm or less.

In an aspect of the present disclosure, the aerogel composite may include an opacifying additive to reduce the radiative component of heat transfer. At any point prior to gel formation, opacifying compounds or precursors thereof may be dispersed into the mixture comprising gel-forming material. Exemplary opacifying additives include, but are not limited to, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof

The process of transitioning gel-forming components into a gel material can also include an aging step (also referred to as curing) prior to liquid phase extraction. Aging a gel material after it reaches its gel point can further strengthen the gel framework by increasing the number of cross-linkages within the network. The duration of gel aging can be adjusted to control various properties within the resulting aerogel material. This aging procedure can be useful in preventing potential volume loss and shrinkage during liquid phase extraction. Aging can involve: maintaining the gel (prior to extraction) at a quiescent state for an extended period; maintaining the gel at elevated temperatures; adding cross-linkage promoting compounds; or any combination thereof.

The time period for transitioning gel-forming materials into a gel material includes both the duration of the initial gel formation (from initiation of gelation up to the gel point), as well as the duration of any subsequent curing and aging of the gel material prior to liquid phase extraction (from the gel point up to the initiation of liquid phase extraction). The total time period for transitioning gel-forming materials into a wet-gel material is typically between about 1 minute and several days, preferably about 30 hours or less, about 24 hours or less, about 15 hours or less, about 10 hours or less, about 6 hours or less, about 4 hours or less, about 2 hours or less, about 1 hour or less, about 30 minutes or less, or about 15 minutes or less. Ideally, the total time period is minimized to allow efficient production of an aerogel. While ethanol is described below as the aging fluid, different process conditions (e.g., temperature and pressure) may be adapted based on the standard temperature and pressure boiling point of the particular aging fluid being used.

Aging of the wet gel material can be accomplished by heating the wet gel material for a time sufficient to complete the aging process. In a typical aging process, a wet gel material is placed into an aging vessel. The wet gel material is then heated to an aging temperature and maintained at the aging temperature until the aging process is complete. Optionally, the wet gel material can be washed with an aging fluid prior to, and during, heating. The aging fluid can be used to replace the primary reaction solvent present in the wet-gel. Exemplary aging fluids are C₁-C₆ alcohols, cyclic alcohols, alicyclic alcohols, aromatic alcohols, polyhydric alcohols, ethers, ketones, or cyclic ethers. Preferred aging fluids include methanol and ethanol. During aging, aging fluid can be substantially continuously passed over and/or through the wet gel material and through the aging vessel. The aging fluid passing through the aging vessel and the wet gel can be fresh aging fluid, or recycled aging fluid.

The amount of time needed to complete the aging process is related to the aging temperature of the wet gel material. Generally, the higher the aging temperature the faster the aging process is completed. The maximum temperature that can be used, however, is limited to the liquid present in the wet gel material. Under atmospheric pressure (1 atm, 101,325 Pa) the aging temperature is limited to the boiling point of the liquid in the wet gel material. Furthermore, it is undesirable to heat the aging material at or near the boiling point of the liquid. Evaporation of the aging fluid as the aging fluid is heated at or near the boiling point of the aging fluid can cause damage to the framework structure of the wet gel material. To reduce the chance of damaging the wet gel material, the aging process is typically conducted below the boiling point of the aging fluid in the wet gel material. For example, when using ethanol as the aging fluid, a wet gel material is typically aged at a temperature of 160° F. (71.1° C.), which is below the boiling point of ethanol (bp 173° F. (78.3° C.) at 1 atm (101,325 Pa)) for a time of from 1 hour up to 24 hours.

In an aspect of the present disclosure, the aging time of a wet gel material can be reduced by increasing the aging temperature of the wet gel material. While the aging temperature is generally limited to the normal boiling point of the aging fluid, the temperature can be increased beyond the normal boiling point of the aging fluid by increasing the pressure in the aging vessel beyond an equilibrium value (i.e., by applying an externally-supplied pressure). To inhibit inadvertent boiling of the aging fluid as the vessel is heated, the vessel is pressurized above the vapor pressure of the liquid during the entire heating process (i.e., when the temperature of the vessel is being raised to the final aging temperature as well as during aging of the wet gel material). When the pressure inside the aging vessel (the “aging pressure”) is maintained above the vapor pressure of the aging fluid, the temperature of the aging fluid can be increased beyond the normal boiling point of the aging fluid without boiling of the aging fluid. As used herein, the “normal boiling point” of a liquid is the temperature at which the liquid boils at 1 atm (101,325 Pa).

In an aspect of the present disclosure, a wet gel material is placed in a vessel that can be pressurized. The vessel also includes an input for the aging fluid and an output for fluid to leave the vessel. The vessel is sealed and aging fluid is introduced into the vessel. The aging fluid may be the same fluid or a different fluid from the fluid used to make the wet gel material. In preferred aspects of the disclosure, the aging fluid is an alcohol (e.g., methanol or ethanol). The aging fluid is heated while maintaining the pressure inside the vessel above the vapor pressure of the aging fluid. The aging fluid can be heated by heating elements situated in or proximate to the vessel.

In an aspect of the present disclosure, during aging of the wet gel material, aging fluid can be removed and aging fluid can be introduced substantially continuously. For example, aging fluid can be recirculated through the vessel. The aging fluid can be heated outside of the vessel before being reintroduced into the vessel. During aging, the pressure inside the vessel (the “aging pressure”) is maintained above the vapor pressure of the liquid, particularly the vapor pressure of the liquid at the aging temperature, since the vapor pressure of the aging fluid will increase with increasing temperature.

Increasing the aging temperature by increasing the pressure allows the aging time to be reduced. Under increased aging temperatures that aging time can be between 40 minutes and about 200 minutes.

Table 1 provides a vapor pressure-temperature table for ethanol. Such a table can be used to determine the minimum pressure inside the vessel that is needed to allow the temperature of the aging fluid to be increased to the desired aging temperature. For example, if an aging temperature of 230 F (110 C) is desired, the vapor pressure inside the vessel will need to be at or above 315 kPa to ensure that the liquid does not begin to damage to the framework structure due to evaporation or boiling. In practice the pressure in the vessel is kept at a pressure that is at least 2 times, at least 3 times, at least 5 times, at least 10 times, or at least 20 times the vapor pressure of the aging liquid. For example, with ethanol as the aging fluid the pressure inside the vessel can be kept at a pressure of at least 630 kPa, at least 945 kPa, at least 1575 kPa, at least 3150 kPa, or at least 6300 kPa.

TABLE 1
Temperature - Vapor Pressure for Ethanol

| | |
|---|---|
| Temperature | Vapor Pressure |

| | | | |
|---|---|---|---|
| 160° F. | (71.1° C.) | 75.6 | kPa |
| 170° F. | (76.7° C.) | 94.9 | kPa |
| 180° F. | (82.2° C.) | 118 | kPa |
| 190° F. | (87.8° C.) | 146 | kPa |
| 200° F. | (93.3° C.) | 179 | kPa |
| 210° F. | (98.9° C.) | 218 | kPa |
| 220° F. | (104.4° C.) | 263 | kPa |
| 230° F. | (110° C.) | 315 | kPa |

To the extent that the aging chemical reactions obey first-order kinetics, every 10° C. increase in temperature will halve the aging time. The relative effectiveness of different aging protocols can be estimated by comparison of the severity factors. The severity factor (R₀) is determined using the equation (1):

$${R}_{0} = t * {e}^{( ( T - T 0 ) / 14.75 ) )} \qquad ( 1 )$$

where “t” is the aging time in minutes, “T” is the aging temperature (° C.), and To is the starting temperature (25° C.). The “normal severity factor” is defined as the severity factor calculated from the time required to age a wet gel material when the wet gel material is heated at a temperature above room temperature (e.g., about 25 C) and below the normal boiling point of the aging fluid at 1 atm pressure.

The severity factor for a given system can be used to predict the aging time for a wet gel material at any given aging temperature. For a given aging process, the normal severity factor, R₀, can be calculated from equation (1). Using the normal severity factor, the aging time (t) can then be calculated for any given temperature from equation (2):

$$t = {R}_{0} / {e}^{( ( T - T 0 ) / 14.75 ) )} \qquad ( 2 )$$

where T₀ is 25 C.

In an exemplary case, an aging process is traditionally conducted with ethanol as the aging fluid at a temperature of 160 F (71.1 C), pressure of 1 atm, for a time of 840 minutes. The normal severity factor can be calculated from equation 1 as shown below:

$${R}_{0} = ( 840 ) * {e}^{( 71.1 - 25 ) / 14.75 )} = 19 , 126.$$

Based on the normal severity factor calculated above, the aging time at any given temperature for the ethanol aging process can be calculated according to equation 2. Table 2 lists the predicted aging time calculated from the normal severity factor (19,126) for the exemplary ethanol aging process.

TABLE 2
Calculated Aging Times Using Severity Factor

| | |
|---|---|
| Aging Temperature | Aging Time |

| | | |
|---|---|---|
| 160° F. | (71.1° C.) | 840 minutes |
| 170° F. | (76.7° C.) | 575 minutes |
| 180° F. | (82.2° C.) | 396 minutes |
| 190° F. | (87.8° C.) | 271 minutes |
| 200° F. | (93.3° C.) | 186 minutes |
| 210° F. | (98.9° C.) | 128 minutes |
| 220° F. | (104.4° C.) | 88 minutes |
| 230° F. | (110° C.) | 60 minutes |

The use of a severity factor to estimate aging time for a gel material can allow the aging time to be determined without the need for extended trial and error testing and waste of material. During formation of an aerogel composition, the gel material is heated in an aging fluid for a time sufficient to complete the chemical reactions that form the gel material framework. Once aging is completed the aerogel composition is produced by removing the liquid from the gel material. After drying, the aerogel composition is tested to ensure that the aerogel framework is intact and that the aerogel composition has the desired properties. Until the aerogel is formed, it is difficult to determine whether the aging time was sufficient to produce an aerogel composition having the desired properties. To ensure that the aging process is completed, excess aging time is used to complete the process. Once the aging time at normal temperature for the aging fluid is determined, the severity factor can be used to determine the new aging time with confidence that the properties of the resulting aging gel will be satisfactory for the desired performance.

As part of the aging process, the resulting wet-gel material may be washed in a suitable secondary solvent to replace the primary reaction solvent present in the wet-gel material. Such secondary solvents may be linear monohydric alcohols with 1 or more aliphatic carbon atoms, dihydric alcohols with 2 or more carbon atoms, branched alcohols, cyclic alcohols, alicyclic alcohols, aromatic alcohols, polyhydric alcohols, ethers, ketones, cyclic ethers or their derivative. In a preferred aspect of the disclosure, the initial wet-gel material comprises water or a mixture of ethanol and water. The water from the initial wet-gel material is washed out with ethanol during the aging process.

Once a gel material has been formed and aged, the liquid phase of the gel can then be at least partially extracted from the wet-gel using extraction methods to form an aerogel material. Liquid phase extraction, among other factors, plays an important role in engineering the characteristics of aerogels, such as porosity and density, as well as related properties such as thermal conductivity. Generally, aerogels are obtained when a liquid phase is extracted from a gel in a manner that causes low shrinkage to the porous network and framework of the wet gel.

Aerogels are commonly formed by removing the liquid mobile phase from the gel material at a temperature and pressure near or above the critical point of the liquid mobile phase. Once the critical point is reached (near critical) or surpassed (supercritical) (i.e., pressure and temperature of the system is at or higher than the critical pressure and critical temperature respectively) a new supercritical phase appears in the fluid that is distinct from the liquid or vapor phase. The solvent can then be removed without introducing a liquid-vapor interface, capillary pressure, or any associated mass transfer limitations typically associated with liquid-vapor boundaries. Additionally, the supercritical phase is more miscible with organic solvents in general, thus having the capacity for better extraction. Co-solvents and solvent exchanges are also commonly used to optimize the supercritical fluid drying process.

One disclosed method of extracting a liquid phase from the wet-gel uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber.

In an aspect of the disclosure, the aging process and the extraction of the liquid can be performed in the same vessel. Use of the same vessel for both the aging and the extraction processes allows the formation of the aerogel composition without removing the aged gel material from the vessel between the heating and extraction steps, and without lowering the temperature or pressure of the vessel between the heating and extraction steps.

In a combined aging and extraction process a wet gel material is placed in a vessel. The vessel is selected to be able to be used at the pressure and temperature required to bring the extraction fluid to supercritical conditions. For example, when carbon dioxide is used as the supercritical fluid, the vessel should be rated for temperatures of at least 35° C. and pressures of at least about 1100 psig. In some aspects the vessel is rated for use at pressures and temperatures significantly above the pressures and temperature needed to achieve supercritical conditions of the extraction fluid. For example, a vessel used for carbon dioxide supercritical extraction should be rated for temperatures above 100 C and pressures above 2500 psig. In a more general aspect, an upper limit of the pressure is limited based on the rated pressure of the vessel.

After placing the wet gel material in the vessel, an aging fluid is introduced into the vessel and the aging process is initiated. As discussed previously, the aging process is conducted at an aging temperature above the normal boiling point of the aging fluid by keeping the pressure of the vessel above the vapor pressure of the aging fluid during heating. Since the vessel was selected to be able to handle the elevated temperature and pressure conditions for supercritical extraction, the vessel is also capable of handling the elevated aging conditions (temperature and pressure) used during the aging process.

Once the aging process is complete, the extraction process is performed in the vessel without removing the aged gel material from the vessel between the aging and extraction steps. After the aging process is complete, an extraction fluid is introduced in the vessel. In a preferred aspect of the disclosure, when transitioning from the aging process to the extraction process, without lowering the temperature or pressure of the vessel between the heating and extraction steps.

After introducing the extraction fluid into the aging vessel, the aged gel material is subjected to an extraction process by passing a supercritical fluid through the vessel. The extraction process is conducted at an extraction temperature and an extraction pressure. The extraction temperature and the extraction pressure are greater than the critical temperature and critical pressure of the extraction fluid. For example, if carbon dioxide is used as the extraction fluid, the extraction temperature is maintained above the supercritical temperature of carbon dioxide (31 C) and the extraction pressure is maintained above the supercritical temperature of carbon dioxide (1000 psi).

As discussed above, the aging process can be conducted at a temperature and pressure above the normal boiling point and the normal vapor pressure of the aging fluid. To minimize stress that can occur when transitioning from the aging process to the extraction process, the vessel is maintained at or above the aging temperature and pressure. For example, in one embodiment, at the end of the aging process, the extraction fluid is introduced into the vessel without lowering the temperature of the vessel or reducing the pressure inside the vessel. In another embodiment, at the end of the aging process, the temperature and pressure inside the vessel is raised to, or near to, the supercritical conditions of the extraction fluid before the extraction fluid is introduced into the vessel.

In an aspect of the disclosure, the aging conditions are performed at, or near the supercritical point of the extraction fluid. For example, if the extraction fluid is supercritical carbon dioxide, the aging pressure is a pressure above the critical pressure of CO₂ and the aging temperature is above the critical temperature of CO₂. For example, when CO₂ is used as the extraction fluid the aging temperature is between about 80 C (186 F) and about 110 C (230 F) and the aging pressure is between about 1000 psi and about 2500 psi during aging of the wet gel material. Preferably, when supercritical CO₂ is the extraction fluid, the wet gel material and aging fluid are heated to an aging temperature of between about 95 C (203 F) and about 110 C (230 F) at an aging pressure between about 1000 psi and about 1500 psi during aging of the wet gel material. By aging the wet gel material at temperatures and pressures at, near, or above the supercritical temperature of the extraction fluid, the stress on the gel material can be minimized during the transition from aging to extraction.

In an aspect of the disclosure, the extraction fluid is introduced into the vessel after the aging process. The temperature and pressure of the extraction fluid entering the vessel is substantially the same as the aging temperature and the aging pressure. After a sufficient amount of the extraction fluid is introduced into the vessel, the temperature and pressure inside the vessel are adjusted to maintain the extraction fluid in the supercritical state. In a preferred embodiment, the extraction fluid is carbon dioxide and the temperature and pressure inside the vessel is maintained at or above the supercritical temperature and pressure of carbon dioxide.

During extraction of the aging fluid from the aged gel material, the extraction fluid is introduced and removed from the vessel substantially continuously during the extraction process. For example, the extraction fluid can be recirculated through the vessel. If the extraction fluid is recirculated, the recirculation loop may include a separator that removes at least some of the aging fluid from the extraction fluid before the extraction fluid is reintroduced into the vessel. The extraction fluid can be heated outside of the vessel before being reintroduced into the vessel. During extraction, the extraction pressure is maintained above the supercritical pressure of the extraction fluid. Likewise, the extraction temperature is maintained above the supercritical temperature of the extraction fluid. For carbon dioxide extraction processes, the vessel is maintained above the supercritical temperature of carbon dioxide (31 C) and the extraction pressure is maintained above the supercritical temperature of carbon dioxide (1000 psi).

Furthermore, the aging fluid resident in pores of the aerogel material is also removed. This “pore fluid” is essentially a mixture of aging fluid and unreacted precursors from the sol state. The composition of pore fluid will, in some aspects, have a varying composition and one that differs from the bulk aging fluid. This is due to the limited diffusion into and out of the pores. Because detectability of pore fluid is practically challenging, the present disclosure refers to the fluids being removed during the extraction process generally, without specifically indicating the presence of pore fluid.

Like the aging process, it is difficult to determine when the extraction process is complete while the extraction is being performed. Since the extraction process is performed at elevated temperature and pressure, it is difficult and time consuming to obtain a sample for testing. Obtaining a sample would require reducing the temperature and pressure so that the sample can be obtained. Furthermore, if the extraction is not complete, the aged gel material would need to be brought back up to the extraction temperature and pressure. The process of increasing the temperature and pressure to supercritical conditions is a time consuming process. Also significant changes in the pressure and temperature within the vessel can place stress on the forming aerogel, possibly damaging the framework of the aerogel.

It is possible to monitor the progress of the extraction process without having to remove the aerogel composition from the vessel. The density of a supercritical fluid changes as the amount of aging fluid dissolve in the supercritical extraction fluid changes. In one aspect of the disclosure, the density of the incoming supercritical fluid is compared to the density of the extraction fluid leaving the vessel. The density of the incoming extraction fluid is at or near the density of the pure extraction fluid. As the extraction fluid passes through the aged gel material, the extraction fluid may mix with the aging fluid to form an extraction/aging fluid mixture. The density of this mixture is, generally, substantially different from the density of the pure extraction fluid. The density of the extraction fluid exiting the vessel will therefore be substantially different from the density of fluid entering the vessel, when a significant amount of aging fluid is present in the vessel/aged gel material. As the extraction process nears completion, the amount of aging fluid in the extraction fluid becomes reduced and the density begins to approach the density of the pure supercritical extraction fluid. When this point is reached during the extraction of the aged gel material, the extraction process can be considered complete. In an aspect of the disclosure, extraction of the aging fluid is continued until the density of the extraction fluid that is removed from the vessel is within about 10%, within about 8%, within about 5%, within about 3%, within about 2%, or within about 1% of the density of the extraction fluid entering the vessel.

As noted above, the density of the mixture of extraction fluid and aging fluid is, generally, substantially different from the density of the pure extraction fluid. In an embodiment the density of the extraction fluid exiting the vessel is periodically or continuously monitored. The density of the extraction fluid can be used to determine the approximate concentration of the extraction fluid in the vessel. As a mixture of extraction fluid and aging fluid is formed, the conditions for the formation of a supercritical fluid will change. In order to maintain the fluid in the vessel at, or near, the supercritical temperature of the extraction fluid/aging fluid mixture, the extraction conditions (extraction temperature and/or extraction pressure) may need to be altered. The density of the extraction fluid passing through the vessel is determined, in part, by monitoring the density of the outgoing extraction fluid. If the density changes significantly, the temperature and/or pressure of the vessel may be raised to bring the extraction fluid back to supercritical conditions. For extractions that are based on supercritical carbon dioxide, the density of the liquid in the vessel should be maintained at a density of 0.30 g/cc to about 0.60 g/cc by adjusting the temperature and/or pressure of the vessel.

Further details describing the synthesis of aerogels can be found in U.S. Patent Application Publication No. 2016/0096949 to Evans et al. and U.S. Patent Application Publication No. 2021/03095227 to Evans et al., both of which are incorporated herein by reference.

Aerogel composites of the present disclosure can have a thickness of 15 mm or less, 10 mm or less, 5 mm or less, 3 mm or less, 2 mm or less, or 1 mm or less.

In an aspect of the present disclosure, the aerogel composite may include an opacifying additive to reduce the radiative component of heat transfer. At any point prior to gel formation, opacifying compounds or precursors thereof may be dispersed into the mixture comprising gel-forming material. Exemplary opacifying additives include, but are not limited to, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof

In some aspects of the disclosure aerogel materials or compositions of the present disclosure are produced in a large scale which requires the use of large scale extraction vessels. Large scale extraction vessels of the present disclosure can include extraction vessels which have a volume of about 0.1 m³ or more, about 0.25 m³ or more, about 0.5 m³ or more, or about 0.75 m³ or more.

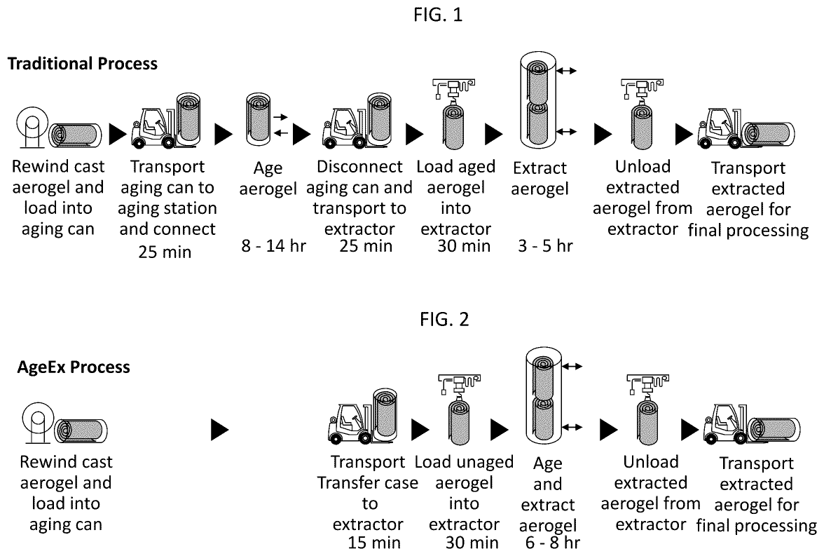

FIG. 1 depicts a schematic diagram of a traditional method of processing a continuous roll of an aerogel. During the formation of the wet-gel material, a continuous roll of the fiber support material is used to supply the fiber support material through a loading system. The loading system includes a container for storing the aerogel precursor solution. As the fiber support material is transported through the loading system, the aerogel precursor solution is applied to the fiber support material. The fiber support material is collected in a take up spool after the aerogel precursor solution has been dispensed onto the material. The supported wet gel material is transported to an aging station where it is placed in an aging vessel. The supported gel material is aged in the vessel as described herein. After the aging process is complete, the supported aged gel material is removed from the aging vessel and transported to an extraction vessel The supported aged gel material is extracted as discussed herein. After the extraction process is complete, the resulting supported aerogel is removed from the extractor and transported to a separate area for final processing.

FIG. 2 depicts a schematic diagram of the improved process in which aging and extraction of the wet gel material is accomplished in the same vessel. The initial steps of forming a supported wet gel material are substantially the same as the process used in the traditional process. Once the supported wet gel material is formed, the material is transported to an extraction vessel. Once loaded into the extraction vessel, the supported wet gel material is first aged. Aging can take place at ambient pressure or, if the extraction vessel is rated for supercritical extraction conditions, the aging process can be performed at elevated temperature and pressure. As discussed previously, aging the wet gel material at elevated temperature and pressure can significantly reduce the aging time. Once the aging process is complete there is no need to move the wet gel material to a different vessel. Instead, the extraction process is initiated by washing the aging fluid out of the vessel with the extraction fluid. The extraction process is then initiated and completed without removing the initial wet gel material from the vessel. As in the traditional process, after the extraction process is complete, the resulting supported aerogel is removed from the extractor and transported to a separate area for final processing

The low thermal conductivity of aerogel materials and aerogel composites makes them ideal materials for insulation applications. In one exemplary use, an aerogel composite may be used as a thermal barrier between individual, or groups of, battery cells. Battery cells are susceptible to catastrophic failure under “abuse conditions.” Abuse conditions include mechanical abuse, electrical abuse, and thermal abuse. One or all of these abuse conditions can be initiated externally or internally. For example, service induced stress, aging, errors in design e.g. configurational parameters such as cell spacing, cell interconnecting style, cell form factor, manufacturing, operation, and maintenance are internal mechanical factors that can cause various kinds of abuse. External mechanical factors include damage or injury to a LIB, such as from a fall or from a penetration of the cell. Electrical abuse conditions mainly include internal or external short-circuiting of a battery cell, overcharge, and over discharge. Thermal abuse is typically triggered by overheating. For example, overheating in a battery cell may be caused by operating the battery cell under high ambient temperatures. Internally, thermal abuse may be caused by electrical and mechanical defects in the battery cells.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

### EXAMPLES

The following examples are included to demonstrate aspects of the disclosure. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific examples which are disclosed and still obtain a like or similar result without departing from the spirit and scope of the invention.

### Method of Aging and Extraction in a Single Vessel

A silica-based wet gel composite composed of a wet gel incorporated into a non-woven fiber reinforcement is obtained as a continuous sheet. The continuous sheet is rolled up onto a support and placed in an aging/extraction vessel. Ethanol is added to the vessel as an aging fluid. The temperature of the ethanol added to the vessel is at 35 C (95 F). The heated ethanol is recycled through the vessel during the aging process by continuously removing ethanol from the vessel while continuously adding ethanol to the vessel.

After introducing the heated ethanol into the vessel, the extraction pressure inside the vessel is raised to an aging pressure of 1100 psig (7584 kPa), initiating the aging process. During the aging process the temperature of the ethanol inside the vessel is raised to 98.9 C (210 F). Additionally, during the aging process the pressure can increase up to about 1500 psig (Pa). The aging process is run for approximately 130 minutes.

When the aging process is complete, the extraction process is initiated. The pressure inside the vessel is raised to the extraction pressure of 2200 psig. The extraction temperature is initially 98.9 C (210 F), the final temperature of the vessel at the end of the aging process. Carbon dioxide is introduced into the vessel and the extraction process is begun by continuously removing carbon dioxide, while carbon dioxide is continuously introduced into the vessel. The carbon dioxide removed from the vessel is decompressed, which causes the carbon dioxide and any ethanol and water carried out of the vessel by the carbon dioxide to separate. The carbon dioxide can be recycled into the vessel after removal of ethanol and water from the carbon dioxide collected at the outlet. Carbon dioxide is introduced into the vessel at or near the current extraction temperature.

The extraction temperature is kept at the aging temperature to minimize stress on the aerogel and save production time. The extraction pressure is approximately 2,200 psig and is adjusted to maintain the density of the supercritical carbon dioxide in the 0.36-0.60 g/cc range.

In one aspect of the disclosure, the extraction fluid can be used as the aging fluid for subsequent aging of wet gel materials. The extraction fluid removed from the vessel is composed of a mixture of the extraction fluid and the aging fluid. The extraction fluid can be maintained at the extraction temperature and extraction pressure and introduced into another vessel for aging of a wet gel material. In this aspect, the amount of aging fluid needed for aging multiple batches of wet gel material can be minimized. Additionally, the reuse of the extraction fluid as the aging fluid can minimize process times for filling (the during the aging step) and draining (during the extraction step). In an exemplary process, supercritical carbon dioxide can be used as the extraction fluid for removing ethanol which was used as the aging fluid. The supercritical carbon dioxide is saturated with ethanol during the extraction process and can be used as the aging fluid in a subsequent aging step.

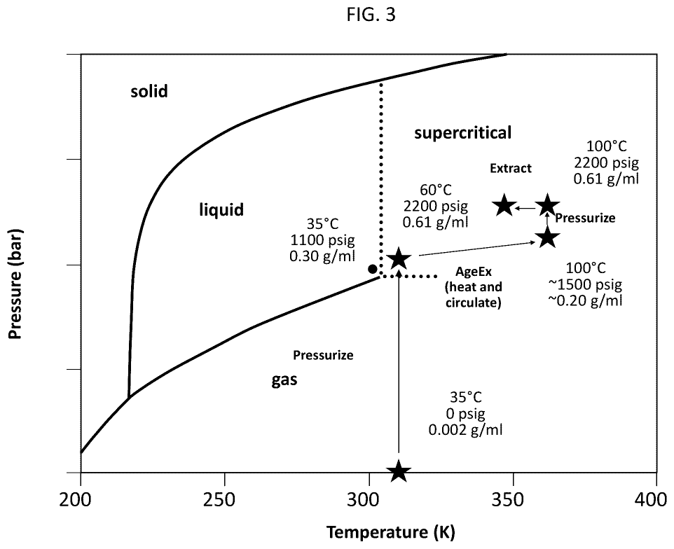

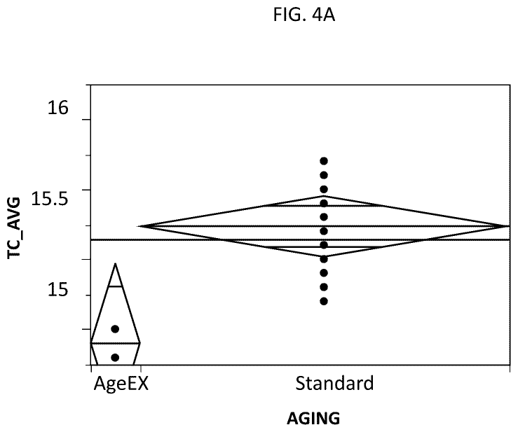

FIG. 3 depicts a schematic diagram of this process superimposed over the phase diagram of CO₂.

By monitoring the density of the carbon dioxide removed from the vessel, three discrete extraction transitions are noted: 1) ejection of the bulk aging ethanol from the vessel, 2) ejection of mixtures of ethanol and carbon dioxide, and 3) ejection of carbon dioxide with less than 10% ethanol/water. The timing and relative separation of these transitions is dependent on the thickness of the aerogel sample. The juncture between the transitions is delineated by characteristic density changes. The extraction endpoint is noted by the convergence of the inlet and outlet densities of the supercritical carbon dioxide. The endpoint can also be predicted based on the vessel volume and the calculated total amount of ethanol removed. Once the extraction endpoint is reached, plus some margin of safety, a drain procedure can be initiated to remove the carbon dioxide from the fully extracted aerogel material. As used herein, references to removing the carbon dioxide refer to the process by which the pressure is reduced so that the carbon dioxide returns to a gaseous state and diffuses out of the aerogel material (replaced by air).

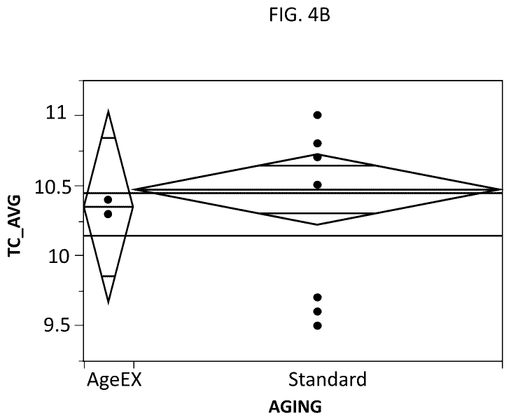

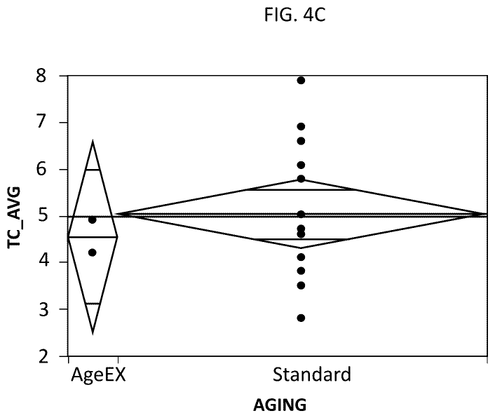

FIG. 4A, FIG. 4B, and FIG. 4C show a comparison of the physical properties of a gel material produced using the combined aging/extraction process compared to a standard process in which aging and extraction are performed in different vessels.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

When used in this specification and claims, the terms “comprises” and “comprising” and variations thereof mean that the specified features, steps or integers are included. The terms are not to be interpreted to exclude the presence of other features, steps or components. The invention comprises, consists of or consists essentially of the disclosed and claimed features.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments, examples and aspects described herein may be combined with one or more features from any other embodiments, examples and aspects described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1. A method of producing an aerogel composition, comprising:
placing a wet gel material in a vessel;
introducing an aging fluid into the vessel;
heating the wet gel material and the aging fluid at an aging temperature and an aging pressure, wherein the aging temperature is above the normal boiling point of the aging fluid, wherein the aging pressure is maintained above the vapor pressure of the aging fluid during heating; and
extracting the aging fluid from the aged gel material with an extraction fluid at an extraction temperature and an extraction pressure, wherein the extraction temperature and the extraction pressure are greater than the critical temperature and critical pressure of the extraction fluid;
wherein heating the wet gel material and extracting the aging fluid from the aged gel material are performed in the vessel without removing the aged gel material from the vessel between the heating and extraction steps, and without lowering the temperature or pressure of the vessel between the heating and extraction steps.

2. The method of claim 1, wherein the wet gel material is obtained by the method comprising:
providing a precursor solution comprising silica gel precursor materials and a solvent; and
allowing the silica gel precursor materials in the precursor solution to transition into a wet gel material, wherein the wet gel material comprises a silica-based framework and the solvent.

3. The method of claim 1, wherein the aging fluid comprises ethanol.

4. The method of claim 1, wherein aging pressure is a pressure above the critical pressure of CO₂ and the aging temperature is above the critical temperature of CO₂.

5. The method of claim 1, wherein the aging temperature is between about 80° C. (86° F.) and about 110° C. (230° F.) and the aging pressure is between about 1000 psi and about 2500 psi during aging of the wet gel material.

6. The method of claim 1, wherein the aging temperature is between about 95° C. (203° F.) and about 110° C. (230° F.) and the aging pressure is between about 1000 psi and about 1500 psi during aging of the wet gel material.

7. The method of claim 1, wherein the wet gel material is aged for a time between about 30 minutes and about 24 hours.

8. The method of claim 1, wherein during aging of the wet gel material, aging fluid is removed and aging fluid is introduced substantially continuously.

9. The method of claim 1, further comprising washing the wet gel material with the aging fluid prior to heating the wet gel material, wherein the aging fluid removes and replaces at least a portion of a liquid present in the wet gel material.

10. The method of claim 1, wherein the wet gel material comprises a reinforcement material.

11. The method of claim 10, wherein the reinforcement material is in the form of a continuous sheet.

12. The method of claim 1, wherein extracting the aging fluid from the aged gel material comprises:
introducing the extraction fluid into the vessel, wherein the temperature and pressure of the extraction fluid entering the vessel is substantially the same as the aging temperature and aging pressure; and
adjusting the temperature and pressure inside the vessel to maintain the extraction fluid in the supercritical state.

13. The method of claim 12, wherein during extraction of the aging fluid from the aged gel material, extraction fluid is removed and extraction fluid is introduced substantially continuously during the extraction.

14. The method of claim 13, further comprising monitoring the density of the extraction fluid that is removed from the vessel.

15. The method of claim 13, where the extraction of the aging fluid is continued until the density of the extraction fluid that is removed from the vessel is within 10% of the density of the extraction fluid entering the vessel.

16. The method of claim 1, wherein the supercritical fluid comprises carbon dioxide.

17. The method of claim 1, further comprising adjusting the pressure inside the vessel to maintain the density of the supercritical fluid between about 0.30 g/cc and 0.60 g/cc.

18. The method of claim 1, further comprising removing fluid from the vessel when the extraction fluid is introduced into the vessel, wherein the removed fluid comprises at least a portion of the aging fluid.

19. The method of claim 1, wherein the aging pressure is maintained at or above the critical pressure of the extraction fluid and above the critical temperature during heating of the wet gel material to form an aged gel material.

20. The method of claim 1, wherein the aging temperature and the aging pressure are raised to the extraction temperature and the extraction pressure prior to introducing the extraction fluid into the vessel.

21. A method of producing an aerogel composition, comprising:
placing a wet gel material in a vessel, the wet gel comprising a silica-based framework;
introducing ethanol into the vessel;
aging the wet gel material by heating the wet gel material and the ethanol at an aging temperature and an aging pressure, wherein the aging temperature is above 80° C. (186° F.), and wherein the pressure of the vessel is maintained above 1000 psi during heating;
introducing carbon dioxide into the vessel, wherein the temperature and pressure of the carbon dioxide entering the vessel is substantially the same as the aging temperature and aging pressure;
extracting the aging fluid from the aged gel material with supercritical carbon dioxide at an extraction temperature and an extraction pressure; and
adjusting the extraction temperature and/or extraction pressure inside the vessel to maintain the carbon dioxide in a supercritical state;
wherein heating the wet gel material and extracting the aging fluid from the aged gel material are performed in the vessel without removing the aged gel material from the vessel between the heating and extraction steps, and without lowering the temperature or pressure of the vessel between the heating and extraction steps.
